(19) United States
(12) Patent Application Publication
(10) Pub. No.: US 2025/0389339 A1
(43) Pub. Date: Dec. 25, 2025

(54) CHECK VALVE

(71) Applicant: FORUM US, INC., Houston, TX (US)

(72) Inventors: Steven POST, Weatherford, TX (US); Roger Lane SUTER, Katy, TX (US)

(21) Appl. No.: 18/751,090

(22) Filed: Jun. 21, 2024

(51) Int. Cl. F16K 15/03; F16K 37/00

(52) U.S. Cl. CPC F16K 15/033; F16K 37/0083

(57) ABSTRACT

A check valve having a valve body, a valve cover, and a flapper valve assembly. The valve body comprises a valve housing and a central bore formed through the valve housing. The central bore has at least a first bore section, a second bore section, and a third bore section. A transition from the second bore section to the third bore section is radiused such that the inner surface of the central bore at the transition is a continuous surface. The flapper assembly is disposed in the central bore of the valve body and comprises a flapper, a valve seat, and a hinge.

### BACKGROUND

### Field

Aspects of the present disclosure relate to a check valve for controlling fluid flow.

### Description of the Related Art

Check valves are configured to permit fluid flow in one direction but prevent fluid flow in another direction. Although there are many different types of check valves, there is a continuous need for new and/or improved check valves.

### SUMMARY

In one embodiment, a check valve having a valve body, a top bore, a valve cover, and a flapper valve assembly. The valve body comprises a valve housing and a central bore formed through the valve housing. The central bore has at least a first bore section, a second bore section, and a third bore section. A transition from the second bore section to the third bore section is radiused such that the inner surface of the central bore at the transition is a continuous surface. The top bore is formed through a top of the valve housing intersecting the central bore. The valve cover is disposed in the top bore of the valve body. The flapper assembly is disposed in the central bore of the valve body and comprises a flapper, a valve seat, and a hinge. The flapper has a downstream side and an upstream side. The valve seat is disposed in the central bore of the valve body and includes a sealing face and an outer surface. The sealing face is configured to seal against the upstream side of the flapper. The outer surface of the valve seat is configured to seal against the inner surface of the central bore of the valve body.

In another embodiment, a method for determining a configuration of a valve comprises coupling a sensor to the valve, pumping fluid in the downstream direction, monitoring the flapper, and providing an indication when the flapper is in the attached configuration or detached configuration. The valve comprises a valve body and a flapper assembly. The sensor is coupled to the valve body. The flapper assembly is disposed in and coupled to the valve body and comprises a flapper in an attached configuration or a detached configuration. When the flapper is in the attached configuration, the flapper is movable between an open position where fluid is allowed to flow through the valve body in a downstream direction and a closed position where fluid is stopped from flowing through the valve body in an upstream direction. When the flapper is in the detached configuration, the flapper is decoupled from the valve body.

In another embodiment, a check valve comprises a valve body, a flapper assembly, and a sensor. The flapper assembly is disposed in the valve body and includes a flapper configurable in an attached configuration or a detached configuration. When the flapper is in the attached configuration, the flapper is movable between an open position where fluid is allowed to flow through the valve body in a downstream direction and a closed position when fluid is stopped from flowing through the valve body in an upstream direction. When the flapper is in the detached configuration, the flapper is decoupled from the valve body. The sensor is coupled to the valve body and is configured to determine whether the flapper is in the attached configuration or the detached configuration and provide an indication when the flapper is in the detached configuration.

### BRIEF DESCRIPTION OF THE DRAWINGS

So that the manner in which the above-recited features of the disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1 illustrates a perspective view of a check valve, according to one embodiment.

FIG. 2 illustrates a sectional view of the check valve of FIG. 1 in a closed position, according to one embodiment.

FIG. 3 illustrates a sectional view of the check valve of FIG. 1 in an open position, according to one embodiment.

FIG. 4 illustrates an enlarged sectional view of a portion the check valve of FIG. 1, according to one embodiment.

FIG. 5 illustrates another sectional view of the check valve of FIG. 1, according to one embodiment.

FIG. 6 illustrates a perspective view of a check valve, according to one embodiment.

FIG. 7 illustrates a sectional view of the check valve of FIG. 6 in a closed position, according to one embodiment.

FIG. 8 illustrates a sectional view of the check valve of FIG. 6 in an open position, according to one embodiment.

FIG. 9 illustrates an enlarged sectional view of a portion of the check valve of FIG. 6, according to one embodiment.

FIG. 10 illustrates another sectional view of the check valve of FIG. 6, according to one embodiment.

FIG. 11 illustrates a perspective view of a check valve, according to one embodiment.

FIG. 12 illustrates a sectional view of the check valve of FIG. 11, according to one embodiment.

FIG. 13 illustrates a partial sectional view of a check valve, according to one embodiment.

FIG. 14 illustrates a method for monitoring a configuration of a check valve, according to one embodiment.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

The disclosure contemplates that terms such as “couples,” “coupling,” “couple,” and “coupled” may include but are not limited to welding, interference fitting, and/or fastening such as by using bolts, threaded connections, pins, clips, and/or screws. The disclosure contemplates that terms such as “couples,” “coupling,” “couple,” and “coupled” may include but are not limited to integrally forming. The disclosure contemplates that terms such as “couples,” “coupling,” “couple,” and “coupled” may include but are not limited to direct coupling and/or indirect coupling, such as indirect coupling through components such as links.

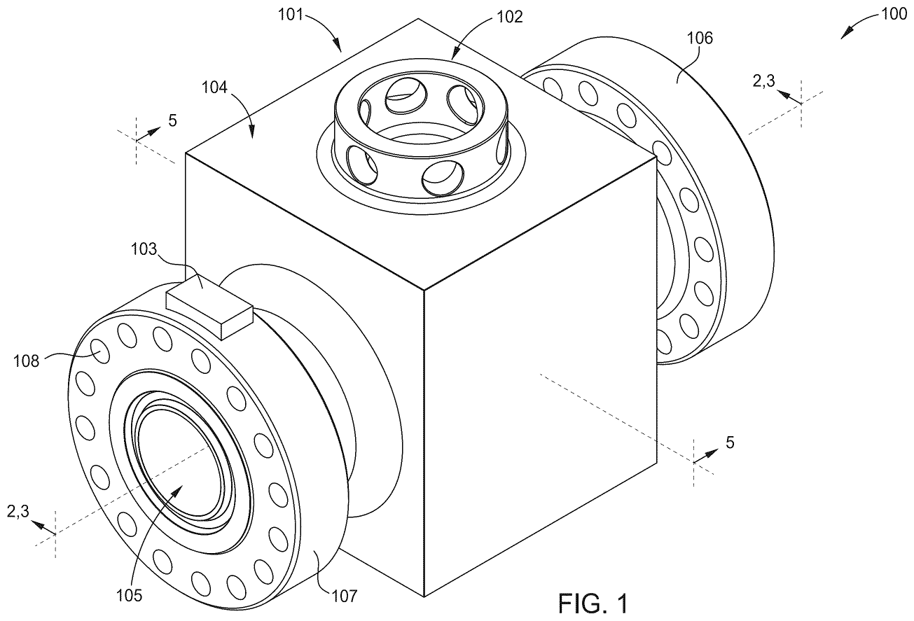

FIGS. 1-5 illustrate one embodiment of a check valve 100.

FIG. 1 illustrates a perspective view of the check valve 100, according to one embodiment. The check valve 100 comprises a valve body 101, a valve cover 102, and a sensor 103. The valve body 101 is configured to contain a fluid. The valve body 101 comprises a valve housing 104 and a central bore 105 extending through the valve housing 104. The valve housing 104 comprises a first flange 106 disposed on one side of the valve housing 104, and a second flange 107 disposed on an opposite side of the valve housing 104. A plurality of holes 108 are disposed through the first and second flanges 106, 107 for receiving fasteners, such as bolts, to couple the check valve 100 to other components. For example, the first flange 106 and the second flange 107 mate to components of a fluid flow system.

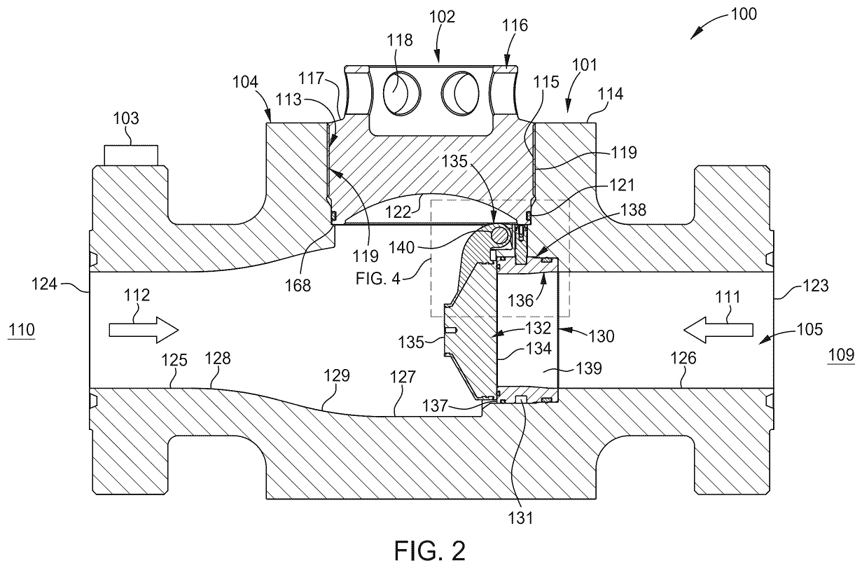

FIG. 2 illustrates a sectional view of the check valve 100 of FIG. 1, according to one embodiment. The check valve 100 has an upstream side 109 and a downstream side 110. Fluid may flow through the central bore 105 from the upstream side 109 to the downstream side 110 in a downstream direction 111. Fluid is prevented from flowing through the central bore 105 from the downstream side 110 to the upstream side 109 in an upstream direction 112 as further described below.

The valve body 101 further comprises a top bore 113 surrounded by a top flange, the top bore 113 is formed through a top 114 of the valve housing 104 intersecting the central bore 105. The top bore 113 may intersect the central bore 105 such that the central axis of the top bore 113 and the central axis of the central bore 105 are perpendicular. The top bore 113 includes an inner surface 115.

The valve cover 102 may comprise an upper portion 116 (e.g. an extrusion) extending from a top surface 117 of the valve cover 102. The upper portion 116 includes a plurality of holes 118 disposed around a circumference of the upper portion 116. The valve cover 102 is disposed in the top bore 113 and is threadedly coupled to the top bore 113 by threads 119 in the valve housing 104. The plurality of holes 118 may receive a tool to rotate the valve cover 102 to install and remove the valve cover 102 from the threaded connection with the top bore 113. The valve cover 102 further comprises a valve cover seal 121. The valve cover seal 121 seals against the inner surface 115 of the top bore 113. The valve cover 102 comprises a valve cover bottom surface 122. The valve cover bottom surface 122 includes a concave portion such that the surface is a reversed dome shape. The valve cover bottom surface 122 also includes a flat portion surrounding the concave portion. The valve cover 102 may be threaded into the top bore 113 such that the flat portion of the valve cover bottom surface 122 abuts a shoulder 168 of the valve housing 104.

The central bore 105 has a first end 123 and a second end 124 and extends through the valve housing 104 from the first flange 106 to the second flange 107. The central bore 105 also has an inner surface 125. The central bore 105 further comprises a first bore section 126, a second bore section 127, and a third bore section 128. The second bore section 127 is disposed between the first bore section 126 and the third bore section 128. The first bore section 126 and the third bore section 128 may have the same diameter. The second bore section 127 may have a larger diameter than the first bore section 126 and the third bore section 128 and may intersect with the top bore 113. The central bore 105 further comprises a transition 129 between the second bore section 127 and the third bore section 128. The transition 129 has a radius of about one inch to about thirty inches such that the inner surface 125 of the central bore 105 at the transition 129 is a continuous surface, such as a continuous tapering surface or a surface that changes in diameter continuously along the length of the surface. In some embodiments, one or more of the first bore section 126, the second bore section 127, and the third bore section 128 have a diameter of about one inch to about ten inches, about 3 inches to about 7 inches, about 3 inches, and about 7 inches.

The check valve 100 further comprises a flapper valve assembly 130. The flapper valve assembly 130 allows fluid flow from the upstream side 109 to the downstream side 110 in the downstream direction 111 but prevents fluid flow from the downstream side 110 to the upstream side 109 in the upstream direction 112. The flapper valve assembly 130 is disposed in the valve housing 104 between the first bore section 126 and the second bore section 127. The flapper valve assembly 130 is disposed in a flapper valve bore section 131 of the central bore 105. The flapper valve assembly 130 comprises a flapper 132 and a hinge 133. The flapper 132 has a flapper upstream side 134 and a flapper downstream side 135. The hinge 133 pivotally couples the flapper 132 to the valve housing 104. The flapper 132 can be in an attached configuration where the flapper 132 is pivotally coupled to the valve housing 104, and in a detached configuration where the flapper 132 is decoupled from the valve housing 104. When the flapper 132 is in the attached configuration, the flapper 132 can be moved between an open position and a closed position. When the flapper 132 is in the detached configuration, the flapper 132 is no longer pivotally coupled to the valve housing 104 and therefore no longer movable between the open position and the closed position. For example, the flapper 132 may be broken off from the hinge 133 such that the flapper 132 is detached from any connection to the valve housing 104 allowing fluid flow through the check valve 100 in either direction.

The flapper valve assembly 130 further comprises a valve seat 136 disposed in the central bore 105. The valve seat 136 has a valve seat sealing face 137, a valve seat outer surface 138, and a valve seat bore 139. The valve seat outer surface 138 seals against the inner surface 125 of the central bore 105. The valve seat sealing face 137 may seal against the flapper upstream side 134. The valve seat bore 139 allows fluid flow through the valve seat 136. In one or more embodiments, the valve seat bore 139 has a varying diameter such that the surface defining the valve seat bore 139 is tapered. In one or more embodiments, the valve seat bore 139 includes diameters ranging from about two inches to about seven inches. In one or more embodiments, the valve seat bore 139 diameter tapers from a larger diameter to a smaller diameter in the downstream direction such that the valve seat 136 acts as a nozzle.

The check valve 100 may be in a closed position when the flapper 132 is in the attached configuration and the flapper upstream side 134 is sealed against the valve seat sealing face 137. When the check valve 100 is in the closed position, the flapper 132 prevents fluid flow in the upstream direction 112.

The sensor 103 is coupled to the valve body 101. The sensor 103 is configured to detect whether the flapper 132 is in the attached configuration or the detached configuration. The sensor 103 may be coupled to the outside of the valve body 101 or may be integrated into the valve body 101. The sensor 103 may be coupled to any component of the valve body 101 including, but not limited to, the sides, top, bottom, and ends of the valve body 101. The sensor 103 may be magnetically coupled (e.g. via a magnetic connection) to the valve body 101 or may be coupled to the valve body 101 by a rigid connection such as by fasteners or by welding. The sensor 103 may also be drilled into the valve housing 104. The sensor 103 may also be installed on the inner surface of the central bore 105. The sensor 103 may also be installed onto or into any component of the check valve 100. The sensor 103 may be an accelerometer. In one embodiment where the sensor 103 is an accelerometer, the sensor 103 may be configured to detect a first vibration profile when the flapper 132 is in the attached configuration, and the sensor 103 may be configured to detect a second vibration profile when the flapper 132 is in the detached configuration. The sensor 103 may also be a proximity sensor. In one embodiment where the sensor 103 is a proximity sensor, the sensor may be configured to detect a first position of the flapper 132 when the flapper 132 is in attached configuration, and may be configured to detect a second position of the flapper 132 when the flapper 132 is in the detached configuration. The sensor 103 may also be comprise a visual or audio indicator configured to indicate when the flapper 132 is in the attached or detached configuration.

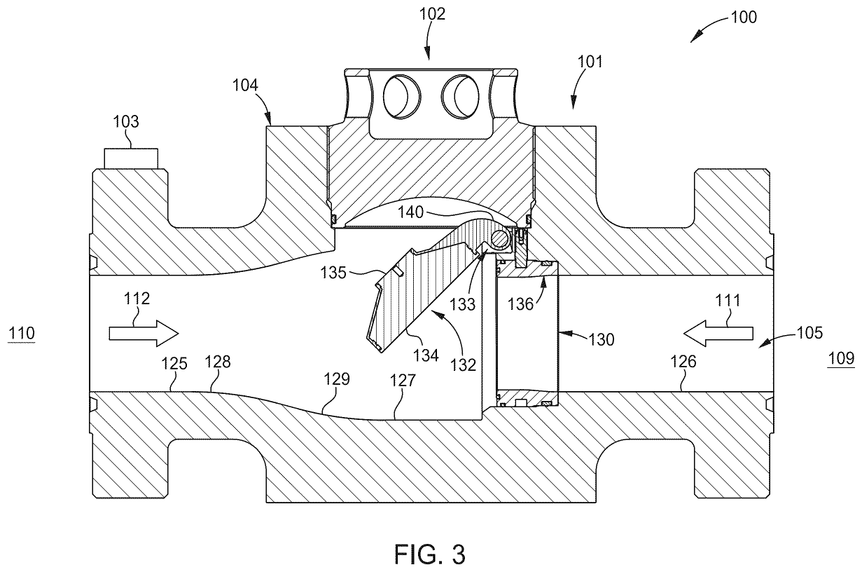

FIG. 3 illustrates a sectional view of the check valve 100 of FIG. 1 with the flapper 132 in an open position, according to one embodiment. In the open position, the check valve 100 allows fluid flow from the upstream side 109 to the downstream side 110 in the downstream direction 111. Fluid may be pumped through the check valve 100 at a pressure sufficient to move the flapper 132 from the closed position to the open position. In the open position, the flapper 132 is in the attached configuration and may be pivoted about an axis defined by a flapper pin 148 disposed in and coupled to a flapper pin bore 140. In the open position, the flapper 132 may be pivoted within a range of 0 to 90 degrees from a vertical axis. The vertical axis being parallel to the flapper upstream side 134 when the flapper 132 is in the closed position (as shown in FIG. 2).

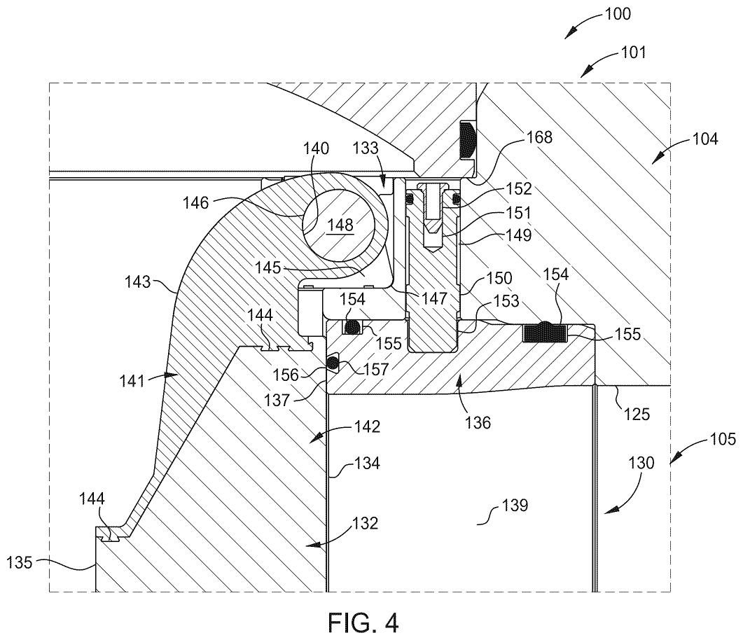

FIG. 4 illustrates an enlarged sectional view of a portion of the check valve 100 of FIG. 1. The flapper 132 has a first flapper body portion 141 and a second flapper body portion 142 which is coupled to the first flapper body portion 141. The first flapper body portion 141 and the second flapper body portion 142 may be made out of different materials. The first flapper body portion 141 may be made out of a metallic material and the second flapper body portion 142 may be made out of a non-metallic material including, but not limited to, urethane, rubber, and/or plastic. The first flapper body portion 141 includes a flapper arm 143 with the flapper pin bore 140. The flapper pin 148 is disposed in and coupled to the flapper pin bore 140. The second flapper body portion 142 comprises the flapper upstream side 134. The second flapper body portion 142 seals against the valve seat sealing face 137.

The first flapper body portion 141 and second flapper body 142 portion are bonded together and mated by one or more dovetail connections 144. The dovetail connections 144 may be located near the central axis of the central bore 105. The dovetail connections 144 may also be located near an outer diameter of the flapper 132.

The hinge 133 comprises a hinge body 145, a hinge body pin bore 146. The hinge 133 may, optionally include a biasing member such as a spring. The hinge body 145 is disposed in a hinge recess 147 of the valve housing 104. The flapper arm 143 is pivotally coupled to the hinge 133 by the flapper pin 148 disposed in and coupled to the flapper pin bore 140 and the hinge body pin bore 146.

The flapper 132 is not pivotally coupled to valve housing 104 by the hinge 133 when in the detached configuration. The detached configuration includes, but is not limited to, when the flapper 132 is not coupled to the valve housing 104 by the hinge 133 and disposed in the second bore section 127 or the third bore section 128, when the flapper 132 is no longer disposed in the valve body 101, when the flapper pin 148 is broken such that the flapper 132 is no longer coupled to the hinge 133, when the hinge 133 is broken such that the flapper 132 is no longer pivotally coupled to the valve housing 104, and when the flapper 132 is broken such that any portion of the flapper 132 is no longer pivotally coupled to the valve housing 104 by the hinge 133.

The check valve 100 further comprises a locking pin 149. The locking pin 149 may be disposed in a locking pin hole 150 of the valve housing 104. The locking pin 149 may further comprise a removal bore 151 and a debris guard 152 disposed in the removal bore 151. The removal bore 151 configured to allow for extraction of the locking pin 149. The debris guard 152 prevents particulate from entering the removal bore 151 thereby preventing removal of the locking pin 149 using the removal bore 151. The locking pin hole 150 is axially aligned with a valve seat groove 153 such that the locking pin 149 may be disposed in the locking pin hole 150 and the valve seat groove 153 thereby axially retaining (e.g. fixing) the valve seat 136 with respect to the valve housing 104.

The valve seat 136 further comprises at least one valve seat outer seal 154. The valve seat outer seal 154 is disposed in at least one valve seat outer seal groove 155 and seals the interface between the valve seat outer surface 138 and the inner surface 125 of the central bore 105. The valve seat sealing face 137 comprises a valve seal sealing face seal 156 disposed in a valve seat sealing face groove 157. The valve seat sealing face seal 156 seals against the flapper upstream side 134 when the flapper 132 is in the closed position.

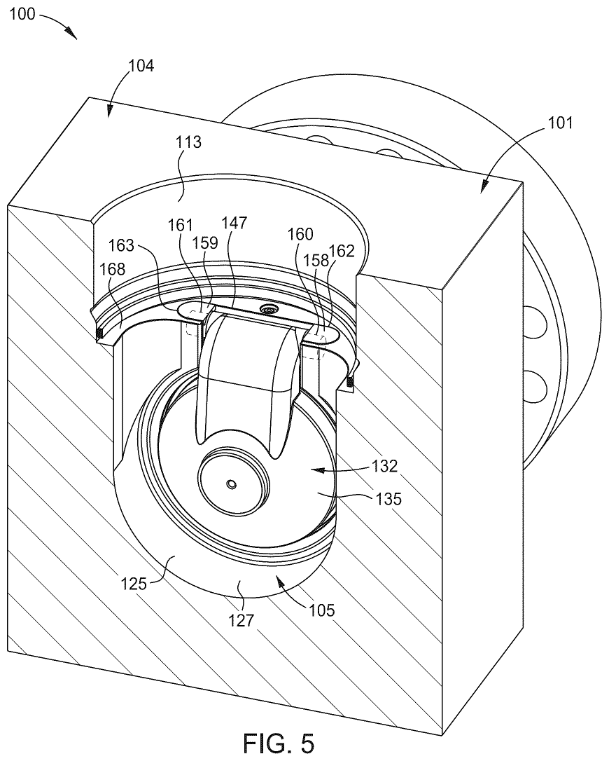

FIG. 5 illustrates another sectional view of the check valve 100 of FIG. 1, according to one embodiment. The hinge body 145 comprises a first hinge body piece 158 and a second hinge body piece 159 with a gap therebetween. The first hinge body piece 158 has a first hinge body pin bore 160 and the second hinge body piece 159 has a second hinge body pin bore 161. The hinge recess 147 of the valve housing 104 comprises a first hinge recess 162 of the valve housing 104 and a second hinge recess 163 of the valve housing 104. The first hinge body piece 158 is disposed in the first hinge recess 162 of the valve housing 104 and the second hinge body piece 159 is disposed in the second hinge recess 163 of the valve housing 104. When the first hinge body piece 158 is disposed in the first hinge recess 162 of the valve housing 104 and the second hinge body piece 159 is disposed in the second hinge recess 163 of the valve housing 104, the first hinge body pin bore 160 is aligned with the second hinge body pin bore 161 and the flapper pin 148 is disposed in both the first hinge body pin bore 160 and the second hinge body pin bore 161. The first hinge body piece 158 and the second hinge body piece 159 may be made of a non-metallic material including, but not limited to, urethane, rubber, and/or plastic.

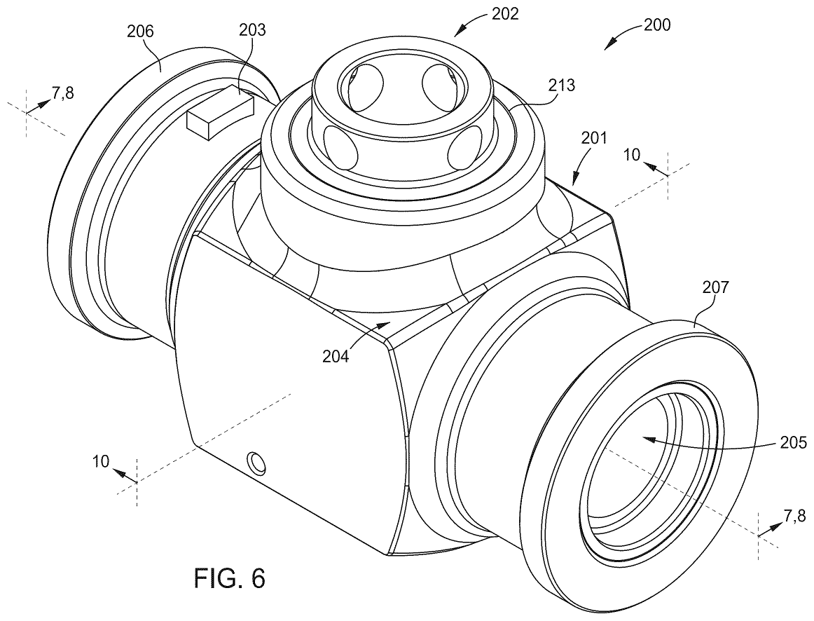

FIGS. 6-10 illustrate one embodiment of a check valve 200. The check valve 200 has similar components as the check valve 100. For brevity, all similar components have been given reference numbers with the same last two digits, and a full description of such similar components may not be repeated herein.

FIG. 6 illustrates a perspective view of the check valve 200, according to one embodiment. The check valve 200 comprises a valve body 201, a valve cover 202, and a sensor 203. The valve body 201 is configured to contain a fluid. The valve body 201 comprises a valve housing 204, a central bore 205, and a top bore 213. In some embodiments, the central bore 205 includes a first bore section 226, a second bore section 227, and a third bore section 228. In some embodiments, one or more of the first bore section 226, the second bore section 227, and the third bore section 228 have a diameter of about one inch to about ten inches, about 3 inches to about 7 inches, about 3 inches, and about 7 inches.

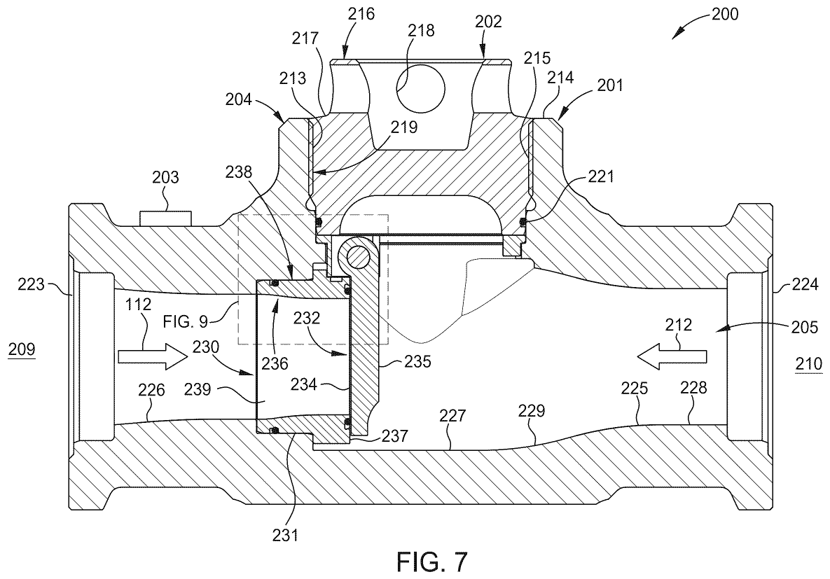

FIG. 7 illustrates a sectional view of the check valve 200 of FIG. 6 with a flapper 232 in a closed position, according to one embodiment. The check valve 200 has an upstream side 209 and a downstream side 210. Fluid may flow through the central bore 205 from the upstream side 209 to the downstream side 210 in a downstream direction 211. Fluid is prevented from flowing through the central bore 205 from the downstream side 210 to the upstream side 209 in an upstream direction 212.

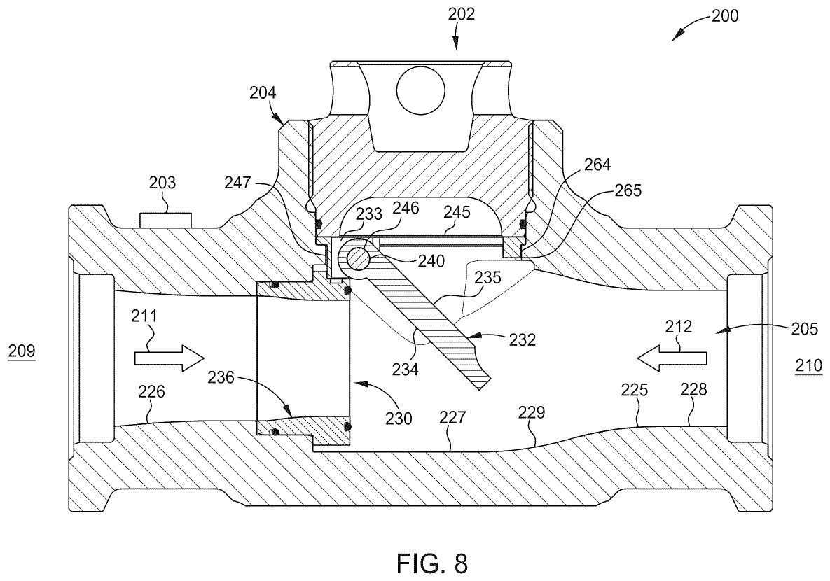

FIG. 8 illustrates a sectional view of the check valve 200 of FIG. 6 with the flapper 232 in an open position, according to one embodiment. The check valve 200 may have a flapper valve assembly 230 comprising the flapper 232, a hinge 233 and a valve seat 236. The hinge 233 comprises a hinge body 245 and a hinge body pin bore 246. The hinge body 245 is disposed in a hinge recess 247 of the valve housing 204. The hinge body 245 may also have a notch 264 disposed in a hinge notch recess 265 in the valve housing 204 wherein the notch 264 and the notch recess 265 of the valve housing 204 are configured to prevent the hinge body 245 from rotating with respect to the valve housing 204.

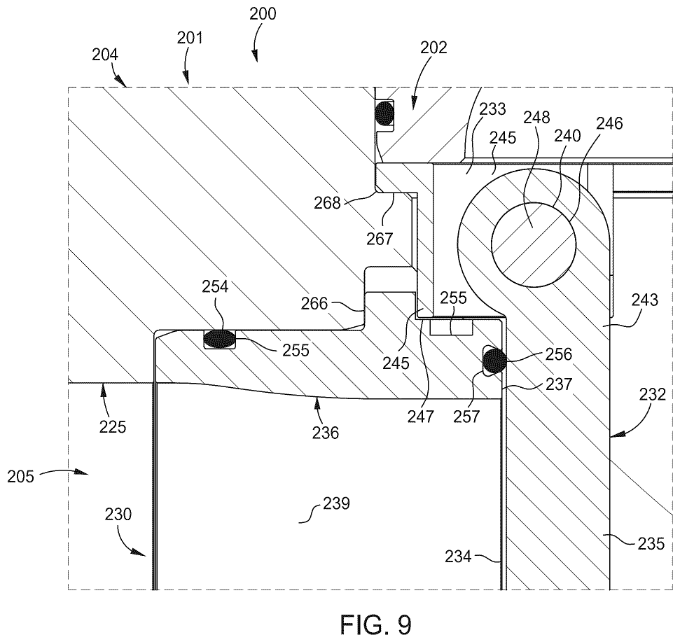

FIG. 9 illustrates an enlarged sectional view of a portion of the check valve 200. The flapper has a flapper upstream side 235 and a flapper downstream side 234. A flapper arm 243 of the flapper 232 is pivotally coupled to the hinge 233 by a flapper pin 248 disposed in and coupled to a flapper pin bore 240 of the flapper 232 and the hinge body pin bore 246.

The valve seat 236 has a valve seat flange 266 contacting the valve housing 204 and the hinge body 245. The hinge body 245 may also have a hinge body flange 267 that sits on a shoulder 268 of the valve housing 204 and the hinge 233 is held in place from above by the valve cover 202.

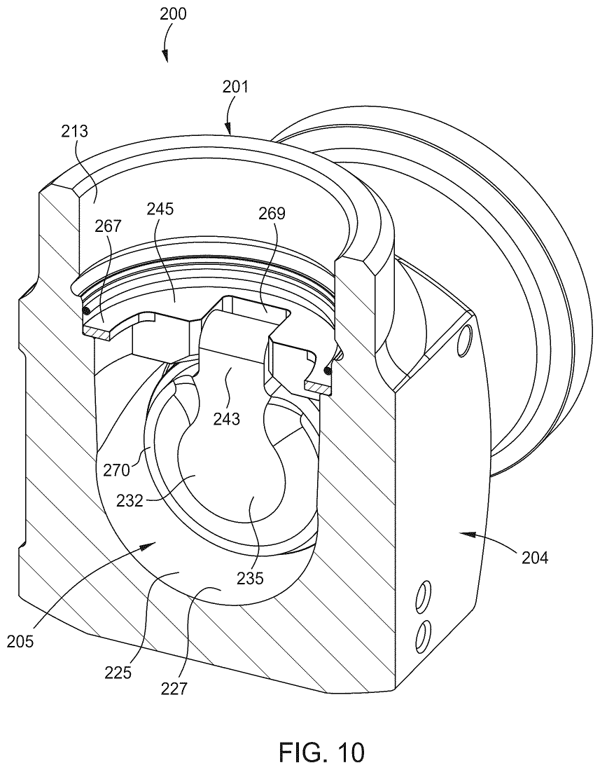

FIG. 10 illustrates another sectional view of the check valve 200 of FIG. 6, according to one embodiment. The hinge body flange 267 creates a complete circle around the inside of the top bore 213. The hinge body 245 further comprises a hinge body recessed portion 269 with the flapper arm 243 disposed in the hinge body recessed portion 269.

The flapper 232 has material removed from a flapper downstream side 235. The material is removed from an outer edge 270 of the flapper 232. The material may be removed such that the thickness of the flapper 232 (defined by the distance between a flapper downstream side 234 of FIG. 9 and the flapper upstream side 235) is less at the outer edge 270 of the flapper 232 than it is at the center of the flapper 232. The removed material may create a concavity at the outer edge 270 of the flapper 232. The material can be removed by machining, or during molding or manufacturing of the flapper 232. The flapper 232 may be made of a metallic material and/or a rubber material including, but not limited to, urethane.

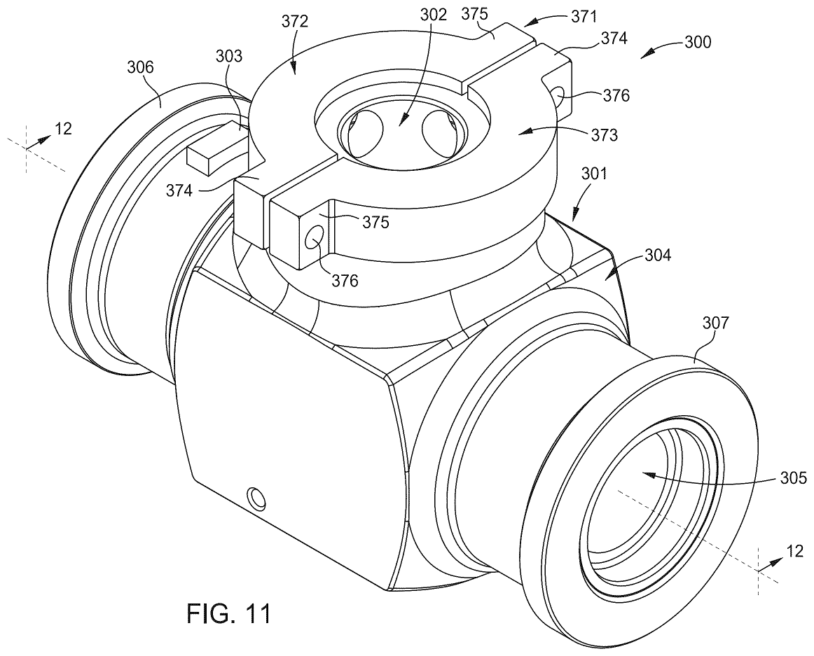

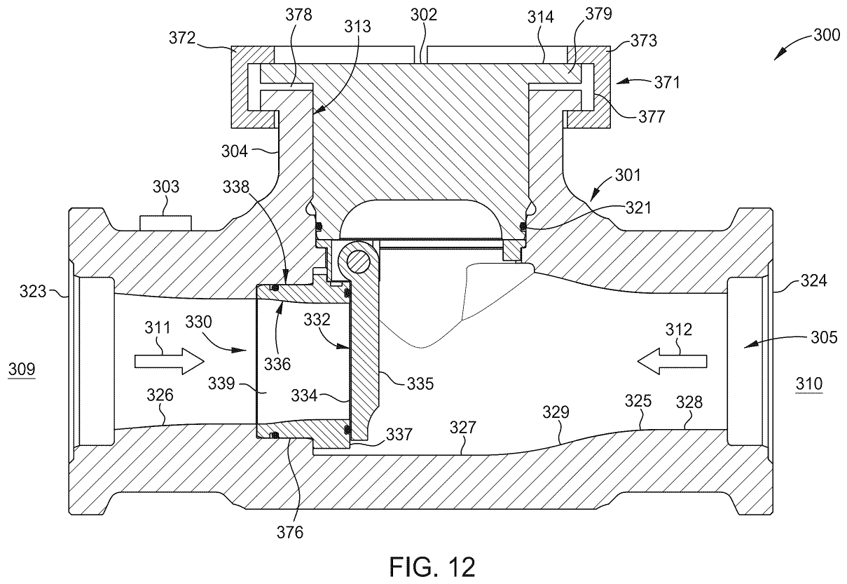

FIGS. 11-12 illustrate one embodiment of a check valve 300. The check valve 300 has similar components as the check valve 200. For brevity, all similar components have been given reference numbers with the same last two digits, and a full description of such similar components may not be repeated herein.

FIG. 11 illustrates a perspective view of the check valve 300, according to one embodiment. The check valve 300 comprises a valve body 301, a valve cover 302, a sensor 303, and a clamp 371. The valve body 301 includes a valve housing 304. The valve cover 302 is coupled to the valve housing 304 by a clamping force of the clamp 371.

The clamp 371 comprises a first clamp body 372 and a second clamp body 373. The first clamp body 372 and the second clamp body 373 are each semi-circular such that, when mated, create a complete circle circumscribing the valve cover 302. The first clamp body 372 and second clamp body 373 each contain clamp mating flanges 374, 375 on either end of the semi-circular first clamp body 374 and second clamp body 373. The clamp mating flanges 374, 375 may have holes 376 disposed through at the ends. The clamp mating flanges 374,375 couple to each other when the clamp 371 is in the assembled configuration by bolting the clamp mating flanges 374, 375 together with fasteners, such as bolts, through the holes 376.

FIG. 12 illustrates a sectional view of the check valve 300 of FIG. 11 in a closed position, according to one embodiment. The clamp 371 may have a C-shaped inner profile containing a channel 377. The valve housing 304 comprises a top bore 313 with a top bore flange 378 surrounding the top bore 313 and protruding from the valve housing 304. The valve cover 302 comprises a valve cover flange 379 on the top surface 314 of the valve cover 302. When the clamp 371 is in the clamped configuration, as shown in FIG. 12, the channel 377 of the clamp 371 encloses the top bore flange 378 of the valve housing 304 and the valve cover flange 379 of the valve cover 302 to clamp them together.

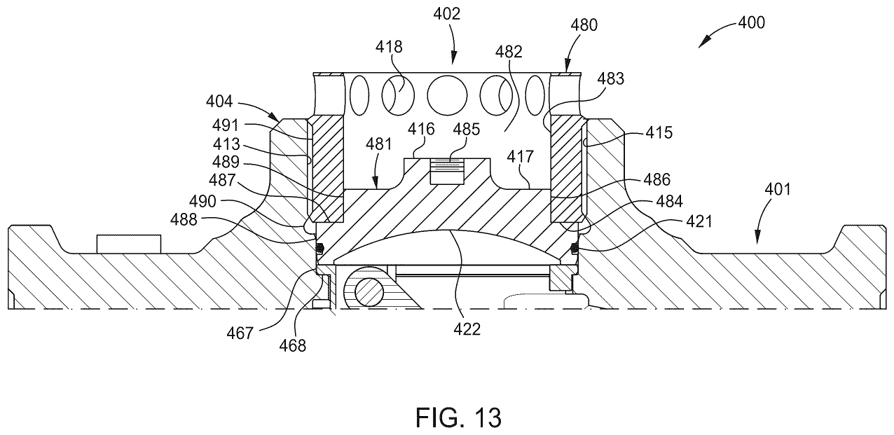

FIG. 13 illustrates a partial sectional view of a check valve 400, according to one or more embodiments. The check valve 400 has similar components to the check valves 100, 200, and 300. For brevity, all similar components have been given reference numbers with the same last two digits, and a full description of such similar components may not be repeated herein.

The check valve 400 comprises a valve body 401 with a valve housing 404 and a top bore 413, and a valve cover 402 disposed in the top bore 413. The valve cover 402 is a two-piece valve cover 402. While the valve cover 402 is shown assembled into an embodiment of the check valve 400 similar to those illustrated in FIGS. 6-12 (e.g. check valves 200 and 300), the valve cover 402 may be assembled into embodiments of the check valve 400 similar to those illustrated in FIGS. 1-5 (e.g. check valve 100).

The valve cover 402 includes a first body 480 and second body 481. The first body 480 is generally cylindrical with a bore 482 defined by an inner surface 483. The first body 480 also includes an outer surface 491 and a bottom surface 484. The first body 480 may include a plurality of holes 418 disposed through the first body 480 from the outer surface 491 to the inner surface 483. In one or more embodiments, the bottom surface 484 is rounded (e.g. convex) in shape from the outer surface 491 to the inner surface 483. That is, the bottom surface 484 may be arcuate in shape such that the bottom surface 484 extends further from the end of the inner surface 483 and the end of the outer surface 491 at radial positions between the inner surface 483 and the outer surface 491. In one or more embodiments, the bottom surface 484 is flat.

The second body 481 includes a top surface 417 with an extrusion 416 extending from the top surface 417. The extrusion 416 may include a tooling hole 485 in the top surface of the extrusion 416 for manipulating, installing, or removing the second body 481. The top surface 417 includes a shoulder 489 disposed around its circumference with a radial abutment surface 486 and an axial abutment surface 487. In one or more embodiments, the axial abutment surface 487 is flat. In one or more embodiments, the axial abutment surface 487 is rounded (e.g. convex) in shape similar to the bottom surface 484 of the first body 480. The second body 481 further includes an outer surface 488 disposed below the shoulder 489 defining the outer circumference of the second body 481. The outer surface 488 includes a groove for supporting a seal 421. The second body 481 further includes a bottom surface 422 which is at least partially flat and, in one or more embodiments, is partially concave at its center.

The first body 480 is at least partially disposed about the second body 481 such that the first body 480 sits on the shoulder 489 of the second body 481. The inner surface 483 of the first body 480 abuts the radial abutment surface 486 of the second body 481, and the bottom surface 484 of the first body 480 abuts the axial abutment surface 487 of the second body 481. In one or more embodiments, the bottom surface 484 of the first body 480 and/or the axial abutment surface 487 of the second body 481 are concave to minimize pre-mature failure.

The first body 480 and the second body 481 are disposed in the top bore 413 of the valve body 401. The outer surface 491 of the first body 480 engages with the inner surface 415 of the top bore 413. The outer surface 491 is threadedly engaged with the inner surface 415 of the top bore 413. The outer surface 488 of the second body 481 has a smaller diameter than the outer surface 491 of the first body 480 and engages with the inner surface 415 of the top bore 413 with the seal 421 (such as with a stepped-down or smaller diameter). The valve housing 404 may include a recess 490 disposed in the inner surface 415 of the top bore 413 at or near the axial location where the first body 480 and second body 481 contact each other.

The second body 481 is disposed between the first body 480 and a hinge body flange 467 which is supported by a shoulder 468 of the valve housing 404. The second body 481 is disposed in the top bore 413 on top of the hinge body flange 467 such that at least a portion of the bottom surface 422 of the second body 481 abuts the hinge body flange 467. The first body 480 is then disposed in the top bore 413 on top of the second body 481 and is threadedly engaged with the inner surface 415 of the top bore 413. The second body 481 is secured at its top end by the abutment of the bottom surface 484 of the first body 480 and the axial abutment surface 487 of the shoulder 489 of the second body 481. The second body 481 is supported at its bottom end by the abutment of the flat portion of the bottom surface 422 with the top surface of the hinge body flange 467. In embodiments without the hinge body flange 267, such as those shown in FIGS. 1-5, the bottom surface 422 abuts and is supported by the shoulder 468 of the valve housing 404.

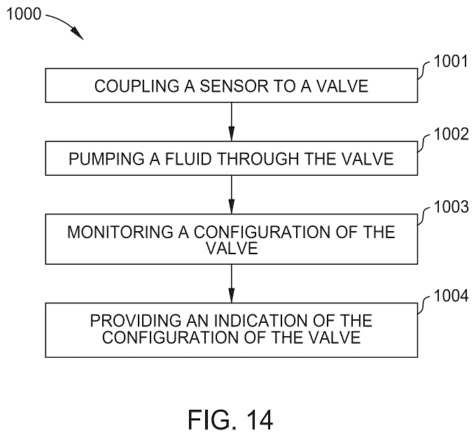

FIG. 14 illustrates a method 1000 for monitoring a configuration of a check valve (such as check valves 100, 200, 300, 400), according to one embodiment. The configurations being monitored may be the attached configuration (including an open position and a closed position) and the detached configuration.

The method 1000 for monitoring the configuration of the check valve comprises a step 1001 of coupling a sensor (such as sensors 103, 203, 303) to the check valve. The method 1000 further comprises a step 1002 of pumping fluid in a downstream direction (such as the downstream direction 111) through the check valve to move the check valve from the closed position to the open position.

The method 1000 further comprises a step 1003 of monitoring the configuration of the check valve, such as the attached configuration (including the open position and the closed position) and the detached configuration. The configuration is monitored by the sensor. The sensor may be an accelerometer and/or a proximity sensor.

Where the sensor is an accelerometer, the step 1003 may include monitoring at least one vibration profile of the check valve. The accelerometer may detect a first vibration profile and a second vibration profile. The first vibration profile is indicative of a flapper (such as the flappers 132, 232, 332) being in a first configuration and the second vibration profile is indicative of the flapper being in a second configuration. For example, the first vibration profile may be indicative of the attached configuration and the second vibration profile may be indicative of the detached configuration.

Where the sensor is a proximity sensor, the step 1003 may include monitoring the position of the flapper. The sensor may detect a plurality of flapper positions which includes a first flapper position and a second flapper position. The first flapper position may be indicative of a first configuration and the second flapper position may be indicative of a second configuration. For example, the first flapper position may be indicative of the flapper being in the attached configuration and the second flapper position may be indicative of the flapper being in the detached configuration.

The method 1000 for monitoring the configuration of the check valve may further comprise a step 1004 of providing an indication of the configuration of the check valve. The configuration indicated may be the attached configuration (including the open position and the closed position) and the detached configuration. The configuration may be indicated by audio and/or visual indication. Audio indication may include, but is not limited to a siren. Visual indication may include, but is not limited to a light, an indication on a user interface, and/or a strobe.

Any one or more components of the check valves 100, 200, 300, and 400 may be integrally formed together, directly coupled together, and/or indirectly coupled together and are not limited to the specific arrangement of components illustrated in FIGS. 1-13. Any one or more of the embodiments of the check valves 100, 200, 300, and/or 400 may be combined in whole or part with any one or more of the embodiments of the check valves 100, 200, 300, and/or 400.

It will be appreciated by those skilled in the art that the preceding embodiments are exemplary and not limiting. It is intended that all modifications, permutations, enhancements, equivalents, and improvements thereto that are apparent to those skilled in the art upon a reading of the specification and a study of the drawings are included within the scope of the disclosure. It is therefore intended that the following appended claims may include all such modifications, permutations, enhancements, equivalents, and improvements. The disclosure also contemplates that one or more aspects of the embodiments described herein may be substituted in for one or more of the other aspects described. The scope of the disclosure is determined by the claims that follow.

1. A check valve, comprising:
a valve body, comprising:
a valve housing;
a central bore formed through the valve housing, wherein the central bore has at least a first bore section, a second bore section, and a third bore section, wherein a transition from the second bore section to the third bore section is radiused such that an inner surface of the central bore at the transition is a continuous surface; and
a top bore formed through a top of the valve housing intersecting the central bore;
a valve cover, wherein the valve cover is disposed in the top bore of the valve body; and
a flapper assembly disposed in the central bore of the valve body, the flapper assembly comprising a flapper, a valve seat, and a hinge, wherein:
the flapper has a downstream side and an upstream side; and
the valve seat is disposed in the central bore of the valve body, the valve seat comprising a sealing face configured to seal against the upstream side of the flapper, and an outer surface configured to seal against the inner surface of the central bore of the valve body.

2. The check valve of claim 1, further comprising: a sensor coupled to the valve body and configured to determine a configuration of the flapper, wherein the configuration of the flapper includes an attached configuration and a detached configuration.

3. The check valve of claim 2, wherein:
the attached configuration is defined as the flapper being pivotally coupled to the valve housing by the hinge and movable between an open position and a closed position; and
the detached configuration is defined as the flapper no longer being pivotally coupled to the valve housing.

4. The check valve of claim 1, the flapper further comprising:
a first body portion; and
a second body portion coupled to the first body portion, wherein the first body portion is made of a non-metallic material and the second body portion is made of a metallic material.

5. The check valve of claim 4, wherein the first body portion of the flapper comprises a flapper arm coupled to the hinge by a pin, and wherein the second body portion of the flapper comprises the upstream side of the flapper.

6. The check valve of claim 4, wherein the first body portion and the second body portion are bonded together and are mated by one or more dovetail connections.

7. The check valve of claim 2, wherein:
the sensor is an accelerometer coupled to the valve body by a magnetic connection; and
the accelerometer is configured to detect a first vibration profile and a second vibration profile, the accelerometer detecting the first vibration profile when the flapper is in the attached configuration and detecting the second vibration profile when the flapper is in the detached configuration.

8. The check valve of claim 2, wherein:
the sensor is a proximity sensor; and
the proximity sensor is configured to detect a first flapper position and a second flapper position, the proximity sensor detecting the first flapper position when the flapper is in the attached configuration and detecting the second flapper position when the flapper is in the detached configuration.

9. The check valve of claim 2, wherein the sensor comprises an indicator, wherein the indicator is one or more of a visual indicator configured to indicate when the flapper is in the detached configuration and a visual indicator configured to indicate when the flapper is in the detached configuration.

10. The check valve of claim 1, wherein:
the flapper further comprises a pin;
the hinge further comprises a hinge body and a pin bore of the hinge body, wherein the pin is disposed in the pin bore of the hinge body and the hinge body is disposed in a recess of the valve housing; and
the hinge body comprising a first hinge body piece made of a non-metallic material and a second hinge body piece made of the non-metallic material and wherein there is a gap between the first hinge body piece and the second hinge body piece.

11. The check valve of claim 1, wherein:
the flapper assembly further comprises a pin;
the hinge further comprises a hinge body and the hinge body is disposed in a recess of the valve housing; and
the hinge body comprising:
a pin bore, wherein the pin of the flapper assembly is disposed in the pin bore;
a notch, wherein the notch of the hinge body is disposed in a hinge notch recess in the valve housing and wherein the notch prevents rotation of the hinge body; and
a flange, wherein the flange of the hinge body is disposed in the recess of the valve body.

12. The check valve of claim 1, wherein:
the valve seat further comprises a groove in the outer surface of the valve seat;
the check valve further comprises a locking pin including a removal bore; and
the valve housing comprises a locking pin hole, wherein the locking pin is disposed in the locking pin hole and the groove of the valve seat and is configured to axially retain the valve seat with respect to the valve housing.

13. The check valve of claim 1, wherein the valve cover comprises a first body including a convex bottom surface and a second body including a flat radial abutment surface, wherein the convex bottom surface engages with the flat radial abutment surface when the first body and the second body are disposed in the top bore of the valve body.

14. The check valve of claim 1, wherein:
the check valve further comprises a clamp;
the valve cover further comprises a flange;
the valve housing further comprises a top flange surrounding the top bore; and
the clamp clamps the flange of the valve cover and the top flange of the valve body together.

15. A method for determining a configuration of a valve, comprising:
coupling a sensor to the valve, the valve comprising:
a valve body, wherein the sensor is coupled to the valve body; and
a flapper assembly disposed in and coupled to the valve body, the flapper assembly comprising a flapper,
wherein when the flapper is in an attached configuration, the flapper is movable between an open position where fluid is allowed to flow through the valve body in a downstream direction and a closed position where fluid is stopped from flowing through the valve body in an upstream direction; and
wherein when the flapper is in a detached configuration, the flapper is decoupled from the valve body;
pumping fluid in the downstream direction;
monitoring the flapper; and
providing an indication when the flapper is in the attached configuration or the detached configuration.

16. The method of claim 15, wherein:
the sensor is an accelerometer; and
monitoring the flapper comprises detecting a first vibration profile and a second vibration profile, the accelerometer detecting the first vibration profile when the flapper is in the attached configuration and detecting the second vibration profile when the flapper is in the detached configuration.

17. The method of claim 15, wherein:
the sensor is a proximity sensor; and
monitoring the flapper comprises detecting a first flapper position and a second flapper position, the proximity sensor detecting the first flapper position when the flapper is in the attached configuration and detecting the second flapper position when the flapper is in the detached configuration.

18. A check valve, comprising:
a valve body;
a flapper assembly disposed in and coupled to the valve body, the flapper assembly comprising a flapper configurable in:
an attached configuration, comprising an open position when fluid is allowed to flow through the valve body in a downstream direction and a closed position when fluid is stopped from flowing through the valve body in an upstream direction; and
a detached configuration when the flapper is decoupled from the valve body;
a sensor coupled to the valve body configured to determine whether the flapper is in the attached configuration or the detached configuration and provide an indication when the flapper is in the detached configuration.

19. The check valve of claim 18, wherein:
the sensor is an accelerometer; and
the accelerometer is configured to detect a first vibration profile and a second vibration profile, the accelerometer detecting the first vibration profile when the flapper is in the attached configuration and detecting the second vibration profile when the flapper is in the detached configuration.

20. The check valve of claim 18, wherein:
the sensor is a proximity sensor; and
the proximity sensor is configured to detect a first flapper position and a second flapper position, the proximity sensor detecting the first flapper position when the flapper is in the attached configuration and detecting the second flapper position when the flapper is in the detached configuration.
